(19) United States
(12) Patent Application Publication
(10) Pub. No.: US 2016/0009602 A1
(43) Pub. Date: Jan. 14, 2016

(54) METHODS FOR REDUCING THE PROCESS-INDUCED SHRINKAGE IN A CERAMIC MATRIX COMPOSITE, AND ARTICLES MADE THEREFROM

(71) Applicant: GENERAL ELECTRIC COMPANY, Schenectady, NY (US)

(72) Inventors: Milivoj Konstantin BRUN, Ballston Lake, NY (US); Gregory Scot CORMAN, Ballston Lake, NY (US)

(21) Appl. No.: 13/790,388

(22) Filed: Mar. 8, 2013

(51) Int. Cl. C04B 35/80; B32B 37/06

(52) U.S. Cl. CPC C04B 35/806; B32B 37/06; B32B 2315/02; B32B 2305/076; B32B 2309/02; B32B 2309/12

(57) ABSTRACT

The disclosure relates generally to a method for reducing the thermal expansion/shrinkage behavior between fiber reinforced plies and monolithic matrix plies, and reducing the macroscopic defects that occur during process of making a ceramic matrix composite article.

### BACKGROUND

The disclosure relates generally to ceramic matrix composites. More particularly, embodiments herein generally relate to in process shrinkage of ceramic matrix composites used in the gas turbine and aerospace industries.

Higher operating temperatures for gas turbine engines are continuously being sought in order to improve their efficiency. However, as operating temperatures increase, the high temperature durability of the components of the engine must correspondingly increase. Significant advances in high temperature capabilities have been achieved through the formulation of iron, nickel, and cobalt-based superalloys. While superalloys have found wide use for components used throughout gas turbine engines, and especially in the higher temperature sections, alternative lighter-weight substrate materials have been proposed.

In recent years, silicon carbide-based ceramic matrix composite (“CMC”) materials have been used with increasing frequency in the manufacture of component parts for gas turbine engines. The known methods for using CMC materials typically involve forming the preform into a desired shape followed by various heat treatment stages and melt-infiltration processing at high temperature using a silicon alloy infiltrant.

Ceramic matrix composites (CMCs) are a class of materials that consist of a reinforcing material surrounded by a ceramic matrix phase. Using these ceramic materials can decrease the weight, yet maintain the strength and durability, of turbine components. Therefore, such materials are considered for many gas turbine components used in higher temperature sections of gas turbine engines, such as airfoils (e.g. blades and vanes), combustors, shrouds and other like components that would benefit from the lighter-weight and improved high-temperature durability these materials can offer.

CMC materials generally comprise a ceramic fiber reinforcement material embedded in a ceramic matrix material. Reinforcing fibers for CMCs are very expensive and prepreg tape with reinforcing fibers is difficult to bend into complex shapes. It is therefore advantageous to use unreinforced matrix material in component locations where the stresses are low or where it is impractical to place reinforced plies. There are problems, however, associated with using unreinforced matrix material with reinforced matrix material, including delaminations and cracking of the CMC during processing. As such, there is a need in the art for new and improved methods for reducing the process-induced shrinkage and defects of ceramic matrix composites, and new improved articles formed therefrom.

### SUMMARY

Aspects of the present disclosure reduce the process-induced shrinkage of unreinforced regions within ceramic matrix composites. One aspect of the present disclosure is directed to a method for making composite structures with reduced macroscopic defects.

One aspect of the present disclosure is directed to a method of making a ceramic matrix composite article with reduced macroscopic defects, said method comprising: forming continuous fiber reinforced prepreg tapes; forming unreinforced matrix tapes, wherein said tapes have chopped or milled fibers and precursors to the ceramic matrix incorporated therein; laying up and laminating the plurality of fiber reinforced prepreg tapes and unreinforced matrix tapes to form a composite preform; and melt infiltrating the composite preform with molten silicon or silicon alloy to form the ceramic matrix composite article.

In one embodiment, the composite is a SiC—SiC ceramic matrix composite. In another embodiment, the prepreg tapes contain precursors to the ceramic composite matrix. In one embodiment, the chopped or milled fibers are carbon fibers comprising particles of from about 1 micron to about 15 microns in diameter and from about 20 microns to about 1 cm in length. In another embodiment, the chopped or milled fibers are silicon carbide fibers comprising particles of from about 5 micron to about 25 microns in diameter and from about 50 microns to about 1 cm in length.

In one embodiment, the chopped or milled fibers are carbon fibers, and said carbon fibers are evenly distributed in the unreinforced matrix material. In another embodiment, the chopped or milled fibers are carbon fibers and said carbon fibers are distributed in the unreinforced matrix material such that the fibers are more concentrated in one portion of the unreinforced matrix material compared to another. The chopped or milled fibers are, in one embodiment, silicon carbide fibers, and said silicon carbide fibers are evenly distributed in the unreinforced matrix material.

In one example, the macroscopic defects include delaminations, matrix cracks or warpage of the ceramic matrix composite, and wherein said macroscopic defects include number and/or degree of defects.

Another aspect of the present disclosure is directed to a method of making a ceramic matrix composite article with reduced macroscopic defects. The method comprises forming continuous fiber reinforced prepreg tapes; forming unreinforced matrix tapes, wherein said tapes have chopped or milled fibers and precursors to the ceramic matrix incorporated therein; laying up and laminating the plurality of fiber reinforced prepreg tapes and unreinforced matrix tapes to form a composite preform; and heat treating the composite preform to form the ceramic matrix composite article. In one embodiment, the heat treatment step comprises melt infiltrating with molten silicon or silicon alloy.

One aspect of the present disclosure is directed to a method for reducing the thermal expansion difference between a fiber reinforced section and a monolithic matrix section of a CMC preform, said method comprising: forming continuous fiber reinforced prepreg tapes; forming unreinforced matrix tapes, wherein said tapes have chopped or milled fibers and precursors to the ceramic matrix incorporated therein; and layering up and laminating the plurality of fiber reinforced prepreg tapes and unreinforced matrix tapes to form a composite preform.

One aspect of the present disclosure is directed to the ceramic matrix composite made by the processes according to the present disclosure. In one embodiment, ceramic composite articles such as combustion chamber liners, transition pieces, turbine blades, turbine vanes, and turbine shrouds are made using the method of the present disclosure.

These and other aspects, features, and advantages of this disclosure will become apparent from the following detailed description of the various aspects of the disclosure taken in conjunction with the accompanying drawings.

### BRIEF DESCRIPTION OF THE FIGURES

The subject matter, which is regarded as the disclosure, is particularly pointed out and distinctly claimed in the claims at the conclusion of the specification. The foregoing and other features, aspects, and advantages of the disclosure will be readily understood from the following detailed description taken in conjunction with the accompanying drawings, wherein:

FIG. 1 shows infra red (IR) transmission thermal diffusivity images of CMC panels having several ply configurations and made, with or without the addition of milled carbon fiber.

FIG. 2 shows a graph of dilatometer results for several composite and monolithic matrix ply compositions.

This patent or application file contains at least one drawing executed in color. Copies of this patent or patent application publication with color drawing(s) will be provided by the Office upon request and payment of the necessary fee.

### DETAILED DESCRIPTION

Reference will be made below in detail to exemplary embodiments, examples of which are illustrated in the accompanying drawings. Wherever possible, the same reference numerals used throughout the drawings refer to the same or like parts.

Ceramic matrix composites (CMCs) are a class of materials that consist of a reinforcing material surrounded by a ceramic matrix phase. Such composites comprising reinforcing fibers are well suited for structural applications because of their toughness, thermal resistance, high-temperature strength, and chemical stability. Such composites have high strength-to-weight ratio that renders them attractive in applications in which weight is a concern, such as in aeronautic applications. Their stability at high temperatures renders them suitable in applications in which the components are in contact with a high-temperature gas, such as in gas turbine engine.

CMC materials generally comprise a ceramic fiber reinforcement material embedded in a ceramic matrix material. The reinforcement material serves as the load-bearing constituent of the CMC in the event of a matrix crack, while the ceramic matrix protects the reinforcement material, maintains the orientation of its fibers, and serves to distribute loads to the reinforcement material. Of particular interest to high-temperature applications are silicon-based composites, such as silicon carbide (SiC) as the matrix and/or reinforcement material. SiC fibers have been used as a reinforcement material for a variety of ceramic matrix materials, including SiC, TiC, Si₃N₄, SiCₓN_{y}, oxide glasses, mullite, cordierite, and Al₂O₃.

Continuous fiber reinforced ceramic composite (CFCC) materials are a type of CMC that offers light weight, high strength, and high stiffness for a variety of high temperature load-bearing applications. A CFCC material is generally characterized by continuous fibers (filaments) that may be arranged to form a unidirectional array of fibers, or bundled in tows that are arranged to form a unidirectional array of tows, or bundled in tows that are woven to form a two-dimensional fabric or woven or braided to form a three-dimensional fabric. For three-dimensional fabrics, sets of unidirectional tows may, for example, be interwoven transverse to each other.

The individual fibers may be coated with a release agent, such as boron nitride (BN) or carbon, forming a weak interface coating that allows for limited and controlled slip between the fibers and the ceramic matrix material. As cracks develop in the CMC, one or more fibers bridging the crack act to redistribute the load to adjacent fibers and regions of the matrix material, thus inhibiting or at least slowing further propagation of the crack.

The production of silicon melt infiltrated CMCs begins with providing a fiber preform which is a porous shaped object made of fibers with a protective coating. A portion of the matrix material is supplied either as particulates or from a ceramic or carbon precursor and an amount of temporary binder. The fibers and matrix precursors are typically assembled into a structure called a preform. The porosity within the fiber preform is then filled with additional matrix precursor material, often a molten metal such as silicon that eventually produces the finished continuous ceramic matrix surrounding the fibers.

A significant problem can occur in the manufacture of CMC preforms prior to and during melt infiltration when the process takes place at high temperature. Given the elevated temperatures and extended time periods necessary for melt infiltration, performs have a tendency to warp and/or shrink to some degree, typically due to the loss of volatile components during heating, such as the resins used to form the preform initially. The industry is well aware of the potential for warpage and or dimensional distortion during heating and MI. There are significant problems encountered by persons skilled in the art, particularly the problem of avoiding shrinkage and/or warping of the preform during heating to the MI temperature.

One technique for fabricating CMC's involves multiple layers of “prepreg,” often in the form of a tape-like structure, comprising the reinforcement material of the desired CMC impregnated with a precursor of the CMC matrix material. The prepreg must undergo processing (including firing) to convert the precursor to the desired ceramic. Multiple plies of the prepreg are stacked and debulked to form a laminate structure, a process referred to as “lay-up.” The prepreg tapes are typically arranged so that tows of the prepreg layers are oriented transverse (e.g., perpendicular) to each other, providing greater strength in the laminar plane of the composite (corresponding to the principal, load-bearing, directions of the final CMC component).

Following lay-up, the laminate will typically undergo further debulking and matrix curing while subjected to applied pressure and an elevated temperature, such as in an autoclave, resulting in a composite “preform”. In the case of melt-infiltrated (MI) CMC articles, the debulked and cured preform undergoes additional processing. First, the preform is heated in vacuum or in an inert atmosphere in order to decompose the organic binders, at least one of which pyrolyzes during this heat treatment to form a carbon char, and produces a porous preform for melt infiltration. Further heating, either as part of the same heat cycle as the binder burn-out step or in an independent subsequent heating step, the preform is melt infiltrated, such as with molten silicon supplied externally. The molten silicon infiltrates into the porosity, reacts with the carbon constituent of the matrix to form silicon carbide, and fills the porosity to yield the desired CMC component.

As used herein, the terms “fiber” or “fibers” include fibers, filaments, whiskers, tows, cloth, mat or felt, and combinations thereof. In one example, fibers suitable for used in the present disclosure are selected from the group consisting of elemental carbon, silicon carbide, silicon nitride, silicon carbo-nitride, silicon carbo-nitro-oxide, silicon carbo-nitro-boro-oxide, fibers made of inorganic oxide materials, and combinations thereof. In another example, suitable fibers for use in the present disclosure include silicon carbide, and said silicon carbide may include B, Ti, Zr, N, Al, Fe or other additives or impurities.

As used herein, “milled carbon” or “chopped carbon” is used to indicate a source of carbon fiber wherein the particles are from about 1 micron to about 15 microns in diameter and from about 20 microns to about 1 cm in length.

The inventors of the instant application discovered that by adding chopped fiber (e.g., carbon or SiC-based) to the unreinforced matrix allows it to be utilized as unreinforced matrix plies in combination with normal reinforced composite plies within a CMC preform structure, and also that the chopped and/milled fiber inhibits the shrinkage of the monolithic matrix plies during processing so that much of the cracking, delaminations and/or deformations are greatly reduced. The inventors conceived that during the melt infiltration process step the carbon fiber would be converted to SiC, so that no net changes in overall CMC composition occurs (i.e. there is no contamination from a different material being incorporated into the CMC).

In one embodiment, the fibers comprise silicon carbide. Reference herein to fibers of silicon carbide includes single-crystal or polycrystalline fibers, or wherein silicon carbide envelops a core of another material, such as carbon or tungsten. The fibers may also comprise organic precursors that will be transformed into silicon carbide at a temperature within the range of temperatures experienced during the fabrication process. Such fibers may also include elements other than silicon and carbon.

Examples of known silicon carbide fibers are the NICALON™ family of silicon carbide fibers available from Nippon Carbon, Japan; Sylramic™ silicon carbide fibers available from COI/ATK, Utah the Tyranno™ family of fibers available from UBE Industries, Japan; and fibers having the trade name SCS-6 or SCS-Ultra produced by Specialty Materials, Inc., Massachusetts.

The inventors of the instant application discovered that by substituting milled carbon fiber for the carbon particulate in the low-carbon matrix composition, they were able to suppress the shrinkage during heating so that at infiltration temperature there is substantially no net expansion. The differential expansion between the normal CMC preform and the matrix with milled carbon fiber has therefore been reduced to about 0.65%. This reduced difference in process shrinkage of the matrix with chopped/milled fiber allows for fabrication of composite structures that mix normal CMC plies with monolithic matrix plies that are free of or have reduced macro defects.

As such, one aspect of the present disclosure is directed to a method of making a ceramic matrix composite article with reduced macroscopic defects. The method comprises forming continuous fiber reinforced prepreg tapes; forming unreinforced matrix tapes, wherein said tapes have chopped or milled fibers and precursors to the ceramic matrix incorporated therein; laying up and laminating the plurality of fiber reinforced prepreg tapes and unreinforced matrix tapes to form a composite preform; and melt infiltrating the composite preform with molten silicon or silicon alloy to form the ceramic matrix composite article. The composite may be a SiC—SiC ceramic matrix composite. The prepreg tapes may contain precursors to the ceramic composite matrix.

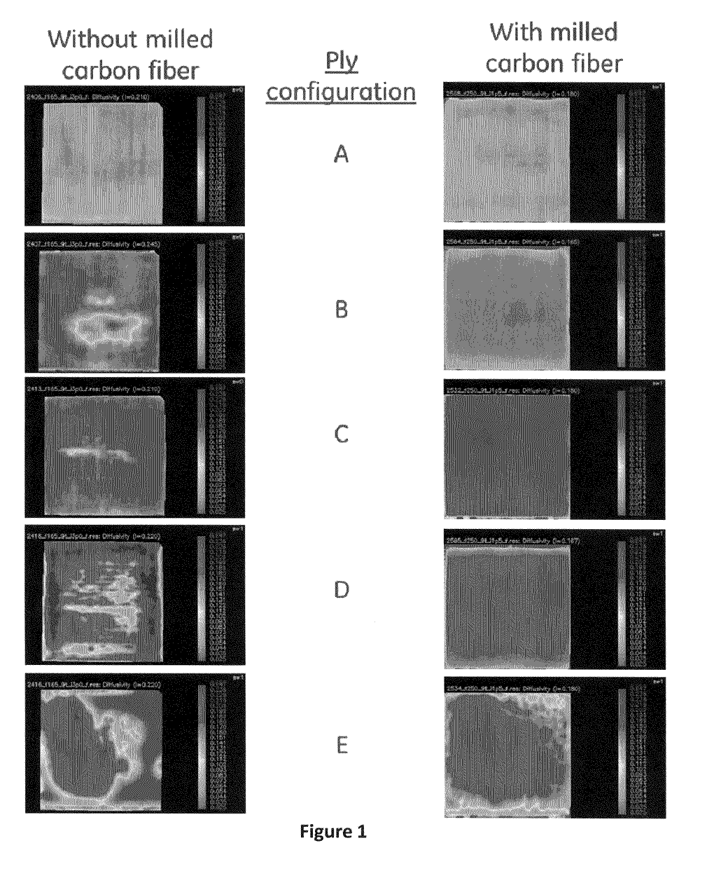

FIG. 1 shows transmission thermal diffusivity non-destructive evaluation (NDE) images generated from a series of CMC panels made with mixtures of fiber reinforced and monolithic plies where the monolithic plies either incorporated or did not incorporate the milled carbon fiber. In the top 4 rows of images, the fiber reinforced and monolithic plies were staggered uniformly throughout the panel thickness. In the bottom row of images, all of the fiber reinforced plies were on one face of the panel and all the monolithic plies were on the opposite face. All of the panels with monolithic plies not incorporating milled carbon fiber showed interlaminar macrodefects, as shown by the color variations in the images. The panels with monolithic plies incorporating milled carbon fiber showed greatly reduced number and type of such defects.

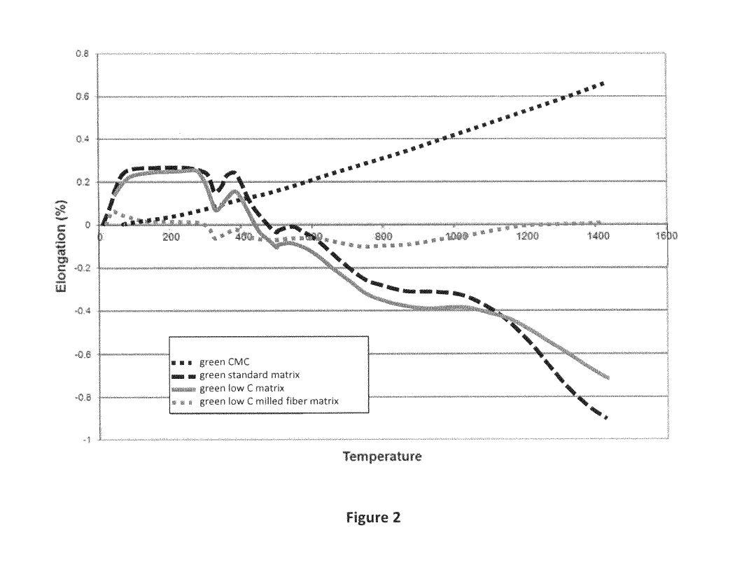

In FIG. 2, the green CMC line shows the expansion behavior of a CMC preform after the autoclave compaction step. The green CMC line therefore captures the expansion behavior of a normal, fiber-reinforced preform during the binder burn-out step and when heating to the melt infiltration temperature.

The expansion of the green preform containing continuous reinforcing fibers is nearly identical to that of the final infiltrated composite, which is due to the expansion of the preform being dominated by the continuous SiC reinforcing fibers. The green standard matrix line shows the behavior of the normal matrix composition with no reinforcing fibers during the same heating cycle. The matrix begins expanding quickly due to the content of organic resins still in the material, but levels off and eventually goes into negative elongation (i.e. shrinkage) as the organics become decomposed and/or pyrolyzed.

At the normal infiltration temperature (about 1420° C.) the matrix sample has shrunk by about 0.9% while the CMC preform sample has expanded by about 0.65%, for a net dimensional difference of about 1.55%. Changing the unreinforced matrix composition to have more SiC particulate and less carbon reduces the net shrinkage slightly (shown by the green low C matrix line in FIG. 2), but there is still a difference of about 1.35% from the CMC preform sample.

The coated reinforcement fiber is by far the most expensive constituent used in fabrication of CMCs. Reducing this fiber content reduces the cost of the component. The specific method of mixing fiber reinforced plies with monolithic matrix plies is an advantageous method in that the distribution of fiber can be controlled through the thickness of the component in accordance with the mechanical stresses on the component. However, attempts at fabricating CMC panels having such structures using the normal matrix slurry composition inevitably led to the generation of interlaminar cracks and/or panel warping.

The inventors of the instant application herein show that at least one significant cause of this cracking and warping is the large difference in thermal expansion/shrinkage behavior between the normal fiber reinforced plies and the monolithic matrix plies (see data in FIG. 2). Furthermore, the inventors of the instant application went on to discover that, surprisingly, by substituting milled carbon fiber for the carbon black particulate normally used in the matrix, the expansion/shrinkage behavior of the monolithic matrix was substantially reduced (for example, by more than half). This reduction in shrinkage was sufficient that panels with mixed fiber reinforced and monolithic matrix plies could now be fabricated with reduced number and extent of macroscopic defects.

Therefore, another aspect of the present disclosure is directed to a method for reducing the thermal expansion difference between a fiber reinforced section and a monolithic matrix section of a CMC preform. The method comprises forming continuous fiber reinforced prepreg tapes; forming unreinforced matrix tapes, wherein said tapes have chopped or milled fibers and precursors to the ceramic matrix incorporated therein; and layering up and laminating the plurality of fiber reinforced prepreg tapes and unreinforced matrix tapes to form a composite preform. In one aspect, the present disclosure is directed to the ceramic matrix composite made by the processes as taught herein.

This discovery allows, for example, for the fabrication of prepreg MI CMC composite structures with reduced and tailorable fiber distributions. Reducing overall fiber content reduces cost, and being able to tailor the fiber distribution allows for the fiber to be placed in the most critical sections of the component.

Another aspect of the present disclosure is directed to a method of making a ceramic matrix composite article with reduced macroscopic defects. The method comprises forming continuous fiber reinforced prepreg tapes; forming unreinforced matrix tapes, wherein said tapes have chopped or milled fibers and precursors to the ceramic matrix incorporated therein; laying up and laminating the plurality of fiber reinforced prepreg tapes and unreinforced matrix tapes to form a composite preform; and heat treating the composite preform to form the ceramic matrix composite article. The heat treatment step may comprise melt infiltrating with molten silicon or silicon alloy.

Preferably, the furnace used for the infiltration process is a carbon furnace; i.e., a furnace the interior of which is constructed essentially from elemental carbon. Such a furnace reacts with any residual oxygen in the furnace atmosphere to produce CO or CO₂ that does not substantially react with the carbon support, the fiber preform, or the precursor of the ceramic matrix material. When a carbon furnace is not used, it is preferable to have a quantity of carbon disposed within the interior of the furnace so that it can react with any residual oxygen in the furnace atmosphere.

Infiltration is performed at greater than or equal to the melting point of the precursor of the ceramic matrix material. In the case of silicon, the infiltration temperature is in a range from about 1400° C. to about 1600° C., from about 1415° C. to about 1500° C., or from about 1420° C. to about 1450° C. Higher temperatures lower the viscosity of molten silicon and promote a better infiltration of the molten silicon into the fiber preform, but they can unnecessarily accelerate a degradation of the fibers and fiber coatings.

As indicated supra, in the fabrication of prepreg melt infiltrated ceramic matrix composites (e.g. GE's HiPerComp®), the highest cost raw material is the SiC reinforcing fibers (Hi-Nicalon family of fiber obtained from Nippon Carbon Co.). A difficult and costly step in the process is coating the fiber tows with the proper debond coatings. Thus, minimizing the amount of fiber needed in a CMC component both reduces the raw material costs and the cost of coating the fiber, thereby reducing the overall cost to produce the component.

The method used for fabrication of prepreg MI CMC materials is to pre-impregnate the fiber tow with matrix precursors using a wet drum winding process, which yields sheets of unidirectionally reinforced prepreg tapes. These tapes are then cut to appropriate size, stacked and laminated together (typically using a vacuum bagging and autoclave compaction procedure) to form a “green” composite preform.

This preform is then put through 2 heating cycles, the first of which decomposes much of the organic binders that were added in the prepregging step, but also pyrolyzes one of the resins to form a carbon char. This carbon char bonds together the fiber, silicon carbide and carbon particulates (also added during the prepregging operation) to maintain the component shape for the melt infiltration step. The second heating cycle is that of the melt infiltration step, whereby the now porous preform is heated in a vacuum to above about 1410° C. while in contact with a source of silicon (inventors used a Si—B alloy). When the silicon alloy melts, it is sucked into the porous composite preform via capillarity. The silicon reacts with carbon particulate and carbon char within the preform to form additional SiC and any remaining space not occupied by SiC or fiber is filled with remaining alloy.

In one embodiment, a method of reducing the overall fiber content of a CMC component comprises replacing normal composite plies with plies containing only the matrix material. In this way, layered structures of CMC plies and monolithic (i.e. not reinforced with SiC fibers) matrix plies can be fabricated and the placement of the CMC plies through the thickness is controlled to best address the expected stress state in the component.

The inventors of the instant application began by making various panels having differing patterns of CMC plies and matrix plies in order to evaluate what effects this substitution would have on the mechanical properties (primarily the in-plane tensile fracture strength) and on the ballistic impact resistance of the material. However, during attempts to make these test panels using the standard matrix slurry composition (compositions 1 and 2 below), the inventors of the instant application found that the panels delaminated and/or warped during the melt infiltration step.

Transmission IR thermography images of several panels made in this study are shown in FIG. 1. The first column is for the panels made using the standard matrix slurry compositions, i.e. those with normal carbon black as an ingredient. The variations in color indicate variations in the thru-thickness thermal diffusivity values, which are in turn indicative of defects (delaminations) within the panels. Panel E, which had all of the composite plies on one face of the panel and all the monolithic plies on the other face, was also severely warped.

In an effort to find a solution, the inventors of the instant application performed a series of dilatometer measurements on green composite ply material and green monolithic matrix material. These samples were fabricated from the same tapes that were used for making the composite panels described above. The dilatometer measures the expansion/shrinkage of the test sample as it is heated through the normal infiltration temperature cycle. FIG. 2 shows the results of these dilatometer measurements.

The lines in FIG. 2 show the expansion behavior of pieces of preform material that had been processed through the autoclave compaction/cure step but before binder burn-out or melt infiltration step. Therefore, the curves represent the expansion/shrinkage behavior one would expect the material would display during heating in these later process steps.

The green CMC line is for normal CMC preform material (0-90 crossply composite with all plies having reinforcing fiber). For this line, the gradual, constant expansion with temperature is characteristic of the continuous SiC fiber present in the composite plies. In contrast, green standard matrix line is for just the matrix alone without reinforcing fibers. This line initially shows a rapid elongation due to the organics still present in the matrix material, but eventually levels off and then shows a large amount of shrinkage.

This overall shrinkage is due to the thermal decomposition and pyrolysis of the organic binders (polyvinyl butyral and phenolic resins). As can be seen in FIG. 2, by 1420° C. (the silicon melt infiltration temperature), the matrix only ply material has shrunk by about 0.9% while the CMC ply material has grown by about 0.65%. This large difference in expansion (about 1.55%) between the composite and monolithic ply materials causes large internal stresses in the panels with mixed composite and matrix only plies, leading to the observed delaminations and panel warpage.

In one aspect, the inventors of the instant application have discovered a method for improving this differential expansion between the composite and monolithic plies and fiber-reinforced plies. In one embodiment, the inventors of the instant application substituted milled carbon fiber with an aspect ratio >10:1 (length:diameter) for the powder carbon ingredient in the matrix slurry. The inventors conceived that the high aspect ratio fibers would form a semi-continuous network of touching fiber fragments that would act as a framework to prevent the shrinkage of the matrix ply material as the organics were being decomposed.

Milled, PAN-based carbon fiber was obtained from Asbury Graphite Mills, New Jersey having a nominal aspect ratio of about 20 (150 micron length and about 8 micron diameter). A direct one-to-one substitution of the milled fiber for the carbon black in the normal slurry formulation was not possible due to the difficulty of mixing high aspect ratio fibers into the slurry. The inventors discovered that they could replace V2 of the normal powder carbon with the milled carbon fiber, while replacing the other V2 of the carbon powder with an equal volume of SiC powder and obtain a slurry with suitable rheology for forming matrix tapes using the tape casting process (composition 3 below).

A matrix-only preform sample was prepared using the new slurry formulation with chopped carbon fiber and used for dilatometry. The green low C milled fiber matrix line in FIG. 2 shows the expansion/shrinkage results for this sample. The expansion difference between the composite and matrix ply material was reduced by more than half.

In order to further confirm that the improvement in matrix shrinkage behavior was due to the addition of the milled carbon fiber and not to the minor change in overall carbon content, an additional sample was made from slurry having the same composition as the milled fiber slurry but using the carbon black powder (composition 4 below). Dilatometry results for this sample are shown by the green low C matrix line in FIG. 2. The net shrinkage behavior of this low-carbon-powder sample was similar to that of the normal composition matrix, indicating that the change in shrinkage behavior of the matrix with chopped carbon fiber was indeed due to the carbon fiber addition, as the inventors conceived, and not to the change in overall carbon content.

The same series of panels originally made with the standard matrix slurry were re-made using monolithic plies made from the new slurry formulation with milled carbon fiber (composition #1 for fiber-reinforced plies and composition #3 for matrix plies). This time all panels remained flat. The infrared NDE images of these new panels are shown in the 2^{nd} column in FIG. 1. The consistent color of the images indicates that they are free of serious internal defects. Only the ply configuration with all composite plies on one face and all monolithic plies on the other face, which is the worst case in terms of exaggerating the differences in expansion of the different types of plies, showed NDE indications, and then only around the panel edges. Even in this case, the size and severity of the defects were greatly reduced compared to the same ply configuration made with the standard matrix. Although the effect was demonstrated using milled carbon fiber, the use of discontinuous SiC fiber should yield the same effect. In one example, carbon fiber is used since it is more readily available and cheaper than SiC fiber.

Those skilled in the art will appreciate that the disclosure is generally applicable to a variety of different CMC fabrication processes using melt infiltration. CMC preforms typically consist of silicon carbide fibers and boron nitride fiber coatings, with SiC and carbon fillers incorporated into the preform, resulting in a preform with a rigid and defined shape. The melt infiltration of silicon into the preform (resulting in matrix densification), normally occurs at temperatures above 1400° C. Although the present disclosure has particular application in the formation of gas turbine parts, the same method could be used in other melt-infiltration manufacturing operations.

All CMC panels and the green CMC dilatometer sample were made using Hi-Nicalon family fiber from Nippon Carbon. The fibers were CVD coated with a fiber debond coating nominally comprising layers of BN, silicon-doped BN, silicon nitride and carbon.

Matrix slurry for fabrication of composite plies was made by mixing the ingredients in a 1 liter polyethylene container with 700 g of zirconia milling media for 15 minutes using a paint shaker. Slurry 1, which was the slurry used for the composite plies of all the test panels, was comprised of silicon carbide powder, carbon black powder, polyvinyl butyral resin, phenolic resin, furfuryl alcohol thinner, dispersant, and using toluene and MIBK as solvents. Slurry 2 for the monolithic matrix plies of the first set of samples (without milled carbon fiber) was comprised of the same materials as slurry 1 except that isopropanol and acetone were substituted as the solvents. Slurry 3 for the monolithic plies of the 2^{nd} set of samples (with milled carbon fiber) was comprised of the same materials as slurry 2 except that ½ of the carbon black powder was replaced with the milled carbon fiber and the other half replaced with an equal volume of SiC powder, and Slurry 4 was for the reduced carbon slurry for dilatometer specimens for comparison to the matrix from slurry 3. Standard reagent grade solvents (toluene, MIBK, isopropanol and acetone) were used throughout.

Tape prepreg to be used for the normal reinforced plies in composite making were fabricated similarly as to that described in U.S. Pat. No. 6,024,898, which is incorporated herein by reference. The fiber tow was prepregged by drawing the tow through a bath of this slurry and then through a conical slurry metering orifice of 0.7 mm to 1 mm. The tow and slurry was then wound onto a 16.5 cm diameter drum to give a total tape width of 15.2 cm. The tape was allowed to dry for about 30 minutes to remove the solvents, and then slit and removed from the drum to yield a sheet of prepreg.

Sheets of monolithic matrix tapes were made by a tape casting process. Slurry formulation 2, as listed above, was used, which differed from slurry 1 only in that ethanol and acetone were substituted for the toluene and MIBK in order to modify the drying characteristics of the slurry and make it more suitable for the tape casting process. Tapes were cast onto Teflon film using a doctor blade height of 0.8 mm and a casting speed of 0.25 meter/minute. After drying this yielded matrix tapes comparable in thickness to the composite tapes made above.

Panels with hybrid structures (i.e. mixtures of composite and monolithic matrix plies) were then laid up by hand using the ply stacking sequences listed in Table 1. Configuration A in the table represents a normal all-CMC panel configuration, and was included in the study as a reference.

TABLE 1
Ply stacking sequence used for producing various hybrid composite/monolithic panels

| Panel | Ply type and fiber orientation* | | | | | | | | | | | | | | | | | |
|---|---|---|---|---|---|---|---|---|---|---|---|---|---|---|---|---|---|---|
| ID | 1 | 2 | 3 | 4 | 5 | 6 | 7 | 8 | 9 | 10 | 11 | 12 | 13 | 14 | 15 | 16 | 17 | 18 |
| A | 0 | 90 | 90 | 0 | 0 | 90 | 90 | 0 | 0 | 90 | 0 | 90 | 90 | 0 | 0 | 90 | 90 | 0 |
| B | M | 0 | 90 | M | 0 | 90 | M | 0 | 90 | 90 | 0 | M | 90 | 0 | M | 90 | 0 | M |
| C | M | 0 | M | 90 | M | 0 | M | 90 | M | M | 90 | M | 0 | M | 90 | M | 0 | M |
| D | M | 0 | M | M | M | 90 | M | M | 0 | 90 | M | M | 90 | M | M | M | 0 | M |
| E | M | 0 | 90 | 0 | 90 | 90 | 0 | 90 | 0 | M | M | M | M | M | M | M | M | M |

*“0” refers to a ply with reinforcing fiber in the 0° direction, “90” is a ply with reinforcing fiber in the 90° direction and “M” refers to a matrix ply without any reinforcing fiber.

The panels were then laminated using a vacuum bagging and autoclave procedure where the panels were compacted at 100 psi and a maximum temperature of 125° C. The “cured” panels were then put through a binder burn-out/pyrolysis heat treatment, which entails slowly heating the samples in a N₂ gas retort furnace to a maximum temperature of 550° C. The resulting porous composite preform panels were then silicon melt infiltrated in a vacuum furnace at <1 Torr pressure by heating them above the melting point of silicon but below 1450° C. for about 1 hour. Molten silicon metal was wicked into the samples using carbon cloth wicks.

Following infiltration, the panel made to configuration E had warped. Transmission IR thermography was used for NDE inspection of the panels, and the resultant images are shown in the 1^{st} column of FIG. 1. In these images, which are based on the measured thru-thickness thermal diffusivity of the panels, a defect shows up as a local variation in colors. Alternately, a consistent color across the panel indicates a freedom of defects. Several of the panels showing NDE indications were subsequently sectioned and the presence of delaminations in the regions of the NDE indications was verified.

The dilatometry experiments described previously were used to understand the cause of the panel warping and delaminations. It was found that composite plies and matrix plies using the standard matrix composition with particulate carbon had a large difference in their expansion/shrinkage behavior when heated to the melt infiltration temperature. Additions of milled carbon fiber suppressed the shrinkage of the monolithic plies, reducing the expansion difference between the composite and monolithic plies by more than 50%.

A second set of panels was made identically to the first set, except that slurry composition 3 (including the milled carbon fiber) was used for the monolithic matrix plies. The new panel with ply configuration E did not warp when going through the melt infiltration step. The IR NDE images of this new set made with the slurry containing the milled carbon fiber are shown in the 2^{nd} column of FIG. 1. In these panels, the colors, and therefore the thru-thickness thermal diffusivities, of the panels are much more uniform, which is indicative of a lack of delamination defects. These panels were later cut into test samples and the absence of interlaminar defects was verified.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the disclosure without departing from its scope. While the dimensions and types of materials described herein are intended to define the parameters of the disclosure, they are by no means limiting and are exemplary embodiments. Many other embodiments will be apparent to those of ordinary skill in the art upon reviewing the above description. The scope of the disclosure should, therefore, be determined with reference to the appended claims, along with the full scope of equivalents to which such claims are entitled.

In the appended description, the terms “including” and “in which” are used as the plain-English equivalents of the respective terms “comprising” and “wherein.” Moreover, in the following claims, the terms “first,” “second,” etc. if any, are used merely as labels, and are not intended to impose numerical or positional requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the disclosure, including the best mode, and also to enable any person of ordinary skill in the art to practice the embodiments of disclosure, including making and using any devices or systems and performing any incorporated methods. The patentable scope of the disclosure is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

While the invention has been described in detail in connection with only a limited number of embodiments, it should be readily understood that the invention is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the invention have been described, it is to be understood that aspects of the disclosure may include only some of the described embodiments. Accordingly, the disclosure is not to be seen as limited by the foregoing description, but is only limited by the scope of the appended claims.

1. A method of making a ceramic matrix composite article with reduced macroscopic defects, said method comprising:
forming continuous fiber reinforced prepreg tapes;
forming unreinforced matrix, tapes, wherein said unreinforced matrix tapes have chopped or milled fibers and precursors to the ceramic matrix material incorporated therein, wherein a diameter of the chopped or milled fibers is from about 1 μm to about 15 μm and a length of the chopped or milled fibers is from about 20 μm to about 1 cm;
laying up and laminating the plurality of fiber reinforced prepreg tapes and unreinforced matrix tapes to form a composite preform; and
melt infiltrating the composite preform with molten silicon or silicon alloy to form the ceramic matrix composite article.

2. The method of claim 1, wherein the composite is a SiC—SiC ceramic matrix composite.

3. The method of claim 1, wherein the prepreg tapes contain precursors to the ceramic composite matrix.

4. The method of claim 1, wherein the chopped of milled fibers are carbon fibers comprising particles of from about 1 micron to about 15 microns in diameter and from about 20 microns to about 1 cm in length.

5. The method of claim 1, wherein the chopped or milled fibers are silicon carbide fibers comprising particles of from about 5 micron to about 25 microns in diameter and from about 50 microns to about 1 cm in length.

6. The method of claim 1, wherein the chopped or milled fibers are carbon fibers, and said carbon fibers are evenly distributed in the unreinforced matrix material.

7. The method of claim 1, wherein the chopped or milled fibers are carbon fibers and said carbon fibers are distributed in the unreinforced matrix material such that the fibers are more concentrated in one portion of the unreinforced matrix material compared to another.

8. The method of claim 1, wherein the chopped or milled, fibers are silicon carbide fibers, and said silicon carbide fibers are evenly distributed in the unreinforced matrix material.

9.-21. (canceled)

22. The method of claim 1, wherein the melt infiltrating comprises melt infiltrating with molten silicon or a molten silicon alloy.

23.-31. (canceled)

32. The method of claim 22, wherein the silicon alloy is Si—B.

33. The method of claim 1, wherein the melt infiltrating is performed in a carbon furnace.

34.-35. (canceled)

36. The method of claim 2, wherein the chopped or milled fibers comprise organic precursors that are transformed into silicon carbide during making of the ceramic matrix composite article.

37. A method of making a ceramic matrix composite article, comprising:
stacking at least one fiber reinforced prepreg tape that is pre-impregnated with a resin precursor of the ceramic matrix material and an organic binder with at least one unreinforced matrix tape that includes chopped or milled fibers and a resin precursor of the ceramic matrix material, wherein a diameter of the chopped or milled fibers is from about 1 μm to about 15 μm and a length of the chopped or milled fibers is from about 20 μm to about 1 cm;
laminating and debulking the stacked tapes to form a green composite preform;
decomposing the organic binder and pyrolizing the resin precursor of the green composite preform to form a carbon char and produce a porous preform; and
melt infiltrating the porous preform with additional matrix precursor material.

38. The method of claim 37, wherein laminating and debulking comprises using a vacuum bagging and autoclave procedure.

39. The method of claim 38, wherein the vacuum bagging and autoclave procedure comprises compacting the tapes at a pressure of 100 psi and a maximum temperature of 125° C.

40. The method of claim 37, wherein decomposing and pyrolizing comprises heating the green composite preform in a vacuum or inert atmosphere at a maximum temperature of 550° C.

41. The method of claim 40, wherein decomposing and pyrolizing comprises heating the green composite preform in a N gas retort furnace.

42. The method of claim 40, wherein melt infiltrating the porous preform comprises melt infiltrating the porous preform in a vacuum furnace at a pressure less than 1 Torr at a temperature between about 1410° C. and about 1450° C. for about 1 hour.

43. The method of claim 42, wherein the vacuum furnace is a carbon furnace.

44. The method of claim 37, wherein the chopped or milled fibers are carbon fibers.

45. The method of claim 37, wherein the chopped or milled fibers are silicon carbide fibers.

46. (canceled)

47. The method of claim 45, wherein the silicon carbide fibers include B, Ti, Zr, N, Al, and/or Fe as additives.

48. (canceled)

49. The method of claim 37, wherein the additional precursor material is molten silicon or a molten silicon alloy.

50. The method of claim 49, wherein the silicon alloy is Si—B.

51. The method of claim 37, wherein stacking the at least one fiber reinforced prepreg tape with the at least one unreinforced matrix tape comprises stacking a plurality of fiber reinforced prepreg tapes with a plurality of unreinforced matrix tapes, and at least two of the fiber reinforced prepreg tapes have fibers transverse to each other.

52. A method of making a ceramic matrix composite article, comprising:
laying up and laminating a plurality of fiber reinforced prepreg tapes and and a plurality of unreinforced matrix tapes to form a composite preform, wherein the plurality of fiber reinforced prepreg tapes are pre-impregnated with a resin precursor of the ceramic matrix material and an organic binder, and the plurality of unreinforced matrix tapes include chopped or milled fibers and a resin precursor of the ceramic matrix material, wherein a diameter of the chopped or milled fibers is from about 1 μm to about 15 μm and a length of the chopped or milled fibers is from about 20 μm to about 1 cm; and
melt infiltrating the composite preform with additional matrix precursor material to form the ceramic matrix composite article.

53. The method of claim 52, wherein laying up comprises stacking stacking plurality of fiber reinforced prepreg tapes with a plurality of unreinforced matrix tapes, and at least two of the fiber reinforced prepreg tapes have fibers transverse to each other.
